(19) United States
(12) Patent Application Publication
(10) Pub. No.: US 2026/0152252 A1
(43) Pub. Date: Jun. 4, 2026

(54) Motorcycle

(71) Applicant: Zhejiang CFMOTO Power Co., Ltd., Hangzhou (CN)

(72) Inventors: Kaida Wang, Hangzhou (CN); Kun Wei, Hangzhou (CN); Yulong Gan, Hangzhou (CN); Xinghai Liu, Hangzhou (CN); Zhaodeng Jin, Hangzhou (CN); Peng Huang, Hangzhou (CN)

(21) Appl. No.: 19/460,237

(22) Filed: Jan. 26, 2026

Related U.S. Application Data
(63) Continuation of application No. PCT/CN2024/072391, filed on Jan. 15, 2024.

(30) Foreign Application Priority Data
Jul. 27, 2023 (CN) 202310939338.2

(51) Int. Cl. B62K 11/04; B62J 1/02; B62J 17/04; B62J 29/00; B62K 25/04

(52) U.S. Cl. CPC B62K 11/04; B62J 1/02; B62J 17/04; B62J 29/00; B62K 25/04

(57) ABSTRACT

A motorcycle has several features beneficial for 60% off-road use, including for people of short stature. The motorcycle frame has sub-frame tubes attached to a main frame at left and right upper sub-frame connection points and left and right lower sub-frame connection points with a sub-frame connection spacing between the connection points. The main frame has a main frame span distance between a head tube axis and the lower sub-frame connection points. A sub-frame connection spacing/main frame span ratio is in the range from 0.16 to 0.24. The upper sub-frame tubes define a riding waist with a ride height over the wheel axis plane. A ride height ratio of the ride height divided by the wheelbase is in the range from 0.26 to 0.4. Left and right inside bottom mounts each include a prime mover assembly mount flange, a rear shock absorber mount flange and a kickstand mount flange.

### RELATED APPLICATION INFORMATION

The present application is a continuation of Application No. PCT/CN 2024/072391, entitled “Motorcycle” and filed Jan. 15, 2024, and claims the benefit of priority to Chinese Patent Application No. 2023109338.2, entitled “Motorcycle”, filed with the Chinese Patent Office on Jul. 27, 2023. The entire contents of the above-referenced applications are incorporated herein by reference.

### FIELD OF THE DISCLOSURE

The present application relates to the field of motor vehicles, and particularly to a motorcycle.

### BACKGROUND OF THE DISCLOSURE

For off-road motorcycles, a larger load-bearing capacity is required, which generally results in configuring the frame size to be larger. After assembling the body cover on the frame, the overall ground clearance of the larger-frame-size motorcycle is increased, which cannot meet the needs of drivers with shorter stature. The excessively high motorcycle body height makes it difficult for the feet of short stature drivers to reach the ground and fully support the motorcycle, which can easily allow the motorcycle to tip over. If only the size of the frame is reduced to meet the usage requirements of different drivers, it will reduce the load capacity of the frame, thereby resulting in the motorcycle being unable to meet off-road needs. Better solutions are needed.

### SUMMARY OF THE INVENTION

The present embodiment provides a motorcycle to solve at least one problem existing in the background.

In a first aspect, the present invention is a motorcycle having a frame, wheels, a prime mover assembly and a vehicle body cover. The frame has a main frame and a sub-frame. The main frame has a head tube, at least one upper main tube extending rearwardly from the head tube, and at least one midframe leg extending downwardly from a rear end of the at least one upper main tube. The head tube has a head tube axis, which the main frame has a longitudinal mid-plane. The sub-frame is fixedly connected to the main frame and extends rearwardly from the rear end of the at least one upper main tube. The sub-frame has left and right upper sub-frame tubes each extending rearwardly from an upper sub-frame connection point where the upper sub-frame tube connects to the main frame, with a riding waist defined between the left and right upper sub-frame tubes. The sub-frame also has left and right lower sub-frame tubes each extending rearwardly from a lower sub-frame connection point where the lower sub-frame tube connects to the main frame. A sub-frame connection spacing is defined between the upper sub-frame connection point and the respective lower sub-frame connection point. A main frame span distance is defined between the head tube axis and a centerline of the lower sub-frame connection points, measured within the longitudinal midplane and perpendicular to the head tube axis. The wheels are connected to the frame and include a front wheel rotating about a front wheel axis and a rear wheel rotating about a rear wheel axis. A wheelbase is defined as a distance between the front wheel axis and the rear wheel axis. A wheel axis plane is defined as a plane containing the front wheel axis and the rear wheel axis. The prime mover assembly is coupled to at least the rear wheel in a transmission mode. The vehicle body cover has a straddle-type seat cushion at least partially arranged above the sub-frame and the main frame. A ride height is defined as an elevation difference between wheel axis plane and the seat cushion directly above the riding waist. A sub-frame connection spacing/main frame span ratio of the sub-frame connection spacing divided by the main frame span distance is in the range from 0.16 to 0.24. A ride height ratio of the ride height divided by the wheelbase is in the range from 0.26 to 0.4.

In another aspect, the main frame has left and right upper main tubes extending rearwardly from the head tube to a main upper cross tube. The main frame also has left and right midframe legs extending downwardly from the main upper cross tube.

In another aspect, the main frame has a main frame bottom mount section fixed to a bottom end of the at least one midframe leg. The main frame bottom mount section has left and right outside bottom mounts, left and right inside bottom mounts and a bottom mount crossbar. The left and right inside bottom mounts each include a prime mover assembly mount flange, a rear shock absorber mount flange and a kickstand mount flange.

Compared with related motorcycles, the motorcycle provided in these embodiments can reduce the overall height of the vehicle while ensuring the stability of the frame structure, thereby meeting the human-machine interaction experience of drivers of different body types including those of shorter stature.

The details of one or more embodiments of the present invention are presented in the following figures and description to make other features, objectives, and advantages of the present invention more concise and understandable.

### BRIEF DESCRIPTION OF THE DRAWINGS

The drawings described herein are intended to explain and provide further understanding of the present invention and provide details of one or more preferred embodiments, but unclaimed specifics shown or discussed do not constitute limitations of the invention. In the figures:

FIG. 1 is a rear left perspective view of a motorcycle according to a preferred embodiment of the present invention, without its rear view mirrors;

FIG. 2 is a rear left perspective view of a frame of the motorcycle of FIG. 1;

FIG. 3 is a left side view of the frame of FIG. 2, further showing a front bracket of the motorcycle of FIG. 1;

FIG. 4 is a top plan view of the frame of FIG. 2;

FIG. 5 is a rear left exploded perspective view of a portion of the frame of FIG. 2, further showing portions of the rear suspension and the kickstand of the motorcycle of FIG. 1;

FIG. 6 is an enlarged view of section 6 of FIG. 5;

FIG. 7 is a simplified rear cross-sectional view of the main frame bottom mount section of FIGS. 2, 3, 5 and 6;

FIG. 8 is a simplified rear cross-sectional view of an alternative main frame bottom mount section for use in the motorcycle of FIG. 1;

FIG. 9 is a front left exploded perspective view of the frame of FIG. 2 together with the fuel tank and seat of the motorcycle of FIG. 1;

FIG. 10 is a side view of a partial structure of the motorcycle of FIG. 1;

FIG. 11 is a right exploded perspective view of the fuel tank and the right body cover side panel of the motorcycle of FIG. 1;

FIG. 12 is a rear left perspective view of the front of the motorcycle of FIG. 1, showing the preferred rear view mirrors and further depicting portions of the preferred windshield support structure both at their lowest and highest positions;

FIG. 13 is an exploded view of the left rear-view mirror assembly of FIG. 12;

FIG. 14 is a vertical cross-sectional view of the pivot joint of the rear-view mirror assembly of FIG. 13 after assembly;

FIG. 15 is a rear left perspective view of the windshield assembly of FIGS. 1 and 12, without showing the support stand of the windshield assembly;

FIG. 16 is a cross-sectional plan view of the windshield assembly of FIGS. 1, 12 and 15, showing the support stand of the windshield assembly; and

FIG. 17 is a rear left exploded perspective view of the adjusting shaft and portions of the windshield mount of the windshield assembly of FIGS. 1, 12, 15 and 16.

### DETAILED DESCRIPTION

The present invention will be described in detail with reference to the specific embodiments shown in the accompanying drawings, but these embodiments do not limit the present invention. Any structural, methodological, or functional changes made by those skilled in the art based on these embodiments are included within the scope of protection of the present invention.

In the description of the present application, it should be noted that the terms “first” and “second” are only used for descriptive purposes and cannot be understood as indicating or implying relative importance or implying the number of technical features indicated. Therefore, the features that are limited to “first” and “second” can explicitly or implicitly include at least one of these features.

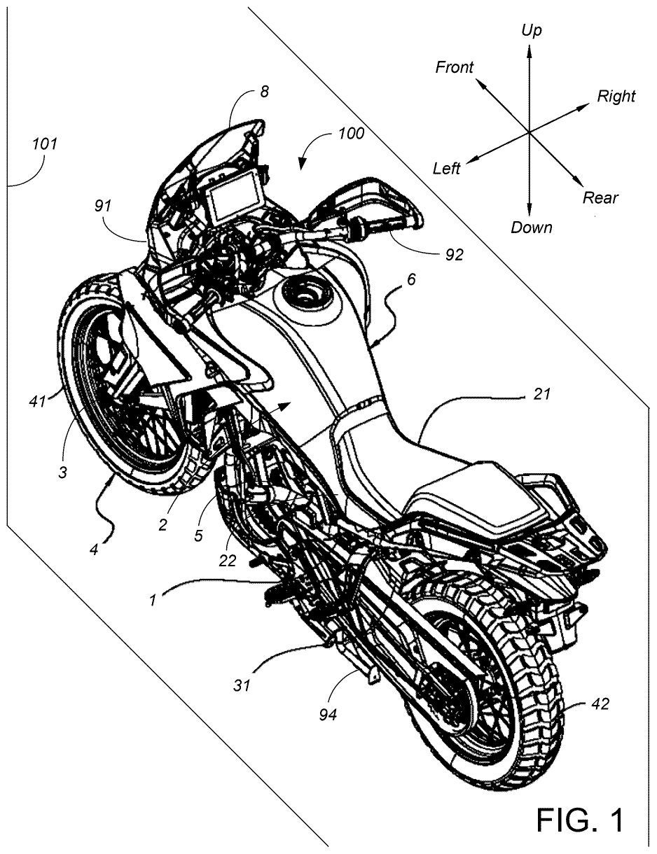

The present invention provides a motorcycle 100 as shown in FIG. 1, intended for substantial off-road use. In particular, about 60% of the expected driving scenarios for the motorcycle 100 of the present invention are off-road scenarios involving passing through complex terrain. When passing over such complex terrain, the driver will frequently switch between sitting riding and standing riding, and/or the driver will maintain a standing riding posture for an extended period of time. The motorcycle 100 of the present invention thus has several features, further explained below, which are particularly beneficial for such substantial off-road use.

The motorcycle 100 includes a frame 1, a vehicle body cover 2, a suspension system 3, wheels 4, and a prime mover assembly 5. The vehicle body cover 2 is at least partially mounted on the frame 1, and includes a straddle-type seat 21. The suspension system 3 is connected to frame 1, and the wheels 4 are connected to frame 1 by means of the suspension system 3. The prime mover assembly 5 is at least partially mounted on the frame 1. The wheels 4 include a front wheel 41 arranged at the front end of the motorcycle 100 and a rear wheel 42 arranged at the rear end of the motorcycle 100. The prime mover assembly 5 supplies torque to the rear wheel 42 in a transmission mode for locomotion for the motorcycle 100. The motorcycle 100 further includes a fuel system 6, at least one and more preferably two rear-view mirror assemblies 7 (not shown in FIG. 1, but shown in FIG. 12), a windshield assembly 8, a lighting system 91 and a steering assembly 92. The directions of “front”, “rear”, “left”, “right”, “up”, and “down” are shown in FIG. 1 and are to be understood assuming the motorcycle 100 is upright with its wheels 4 on level ground.

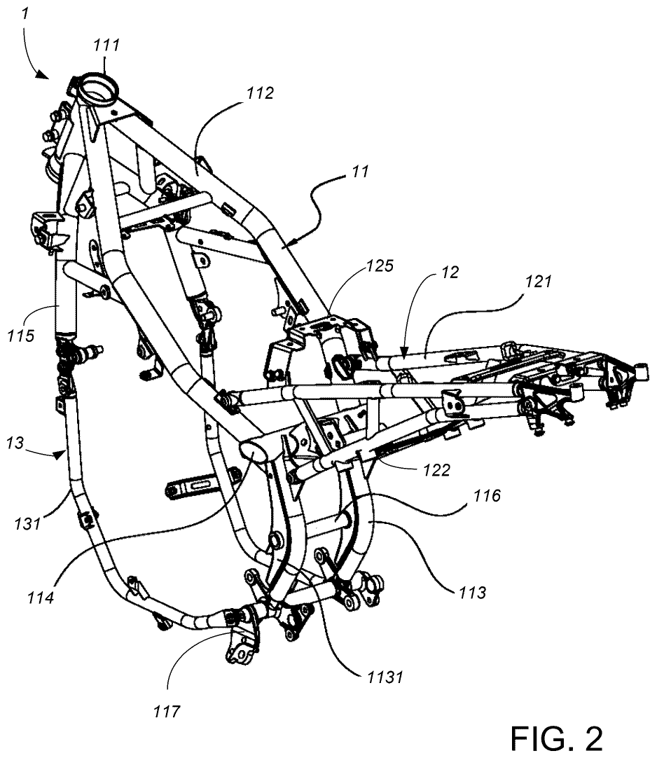

The frame 1 is configured as a tubular structure as better shown in FIGS. 2-4, which is preferably generally symmetrical with respect to a longitudinal midplane 101. The frame 1 includes a main frame 11, a sub-frame 12, and an underframe 13. The main frame 11 is positioned on the front side of the motorcycle 100, behind a front wheel axis 411 (called out in FIG. 10) and forward of substantially all of the rear wheel 42. The sub-frame 12 is fixedly (and preferably detachably) connected to the main frame 11, extending rearwardly from the main frame 11 and at least partially over the rear wheel 42. The underframe 13 is positioned on the lower side of the main frame 11 at least partially under the prime mover assembly 5, and the underframe 13 is a detachably connected to the main frame 11.

The frame 1 is preferably formed of metal such as steel, and the connection methods for forming each of the main frame 11 and sub-frame 12 include but are not limited to welding and integral molding. That is, the main frame 11 is preferably a single weldment, and the sub-frame 12 is preferably a separate single weldment. The underframe 13 is preferably two bent tubes 131, which could alternatively be joined as another separate single weldment by adding cross-members (not shown).

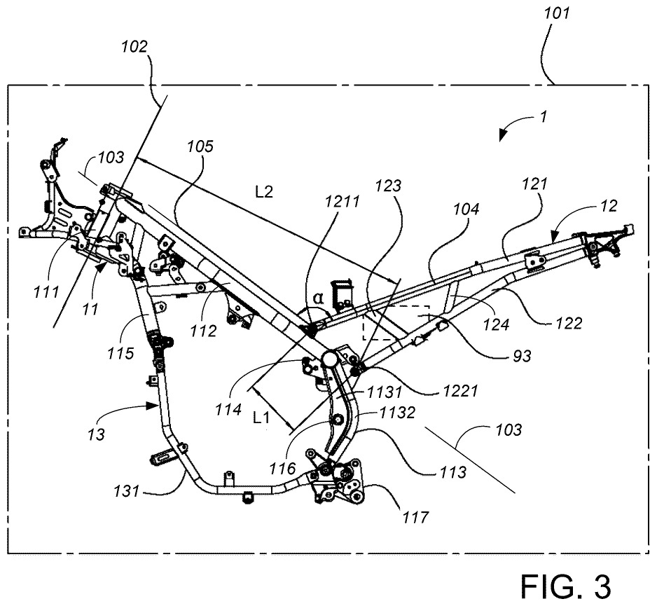

The preferred main frame 11 includes a head tube 111, left and right upper main tubes 112, at least one and more preferably left and right vertically-extending midframe legs 113, and a main upper cross tube 114. The main frame 11 also preferably includes left and right descending tubes 115, a middle crosstube 116, and a main frame bottom mount section 117. The head tube 111 is at the front of the main frame 11, at least partially connected to the suspension system 3. The head tube 111 defines a head tube axis 102 (called out in FIG. 3), which is also the steering pivot axis of the steering assembly 92. The upper main tubes 112 are fixedly connected to and extend rearwardly from the head tube 111, providing the backbone of the main frame 1. The upper main tubes 112 also preferably slope somewhat downwardly from the head tube 111. In side view such as in FIG. 3, the upper main tubes 112 are substantially straight, such that the upper main tubes 112 collectively define an upper main tube slope plane 103. The midframe legs 113 are fixedly connected to and extend generally vertically from rear ends of the upper main tubes 112. The main upper cross tube 114 is arranged between the left and right upper main tubes 112 and the left and right vertically-extending midframe legs 113 substantially at the junction between the upper main tubes 112 and the midframe legs 113, extending along the width direction. The main upper cross tube 114 is fixedly connected to both the upper main tubes 112 and the vertically-extending midframe legs 113. The descending tubes 115 are fixed to the head tube 111 lower than the upper main tubes 112, with left and right descending tubes 115 generally positioned underneath respective left and right upper main tubes 112, but with the descending tubes 115 descending at a greater pitch than the upper main tubes 112. The front of the underframe 13 attaches to bottom ends of the descending tubes 115.

The preferred midframe legs 113 each include a midframe reinforcement plate 1131 as shown in FIGS. 2, 3 and 6. Each midframe reinforcement plate 1131 extends in a vertical-longitudinal plane in front of and within a bend 1132 of the respective left or right midframe leg 113 to enhance the structural strength of the midframe leg 113. The middle cross tube 116 preferably extends along the width direction between the pair of midframe reinforcement plates 1131. The suspension system 3 further includes a rear fork 31 with its front end pivotally connected to the middle cross tube 116 and its rear end rotatably connecting to the rear wheel 42. The midframe reinforcement plates 1131 help to absorb forces from the rear fork 31 as the rear wheel 42 bounces and shakes over rough ground or trails, thereby avoiding the deformation of the midframe legs 113.

The sub-frame 12 includes left and right upper sub-frame tubes 121 and left and right lower sub-frame tubes 122. The lower sub-frame tubes 122 are each generally aligned with the respective upper sub-frame tube 121 along the height direction, running longitudinally underneath the respective upper sub-frame tube 121. In side view such as in FIG. 3, the upper sub-frame tubes 121 are substantially straight at least along a majority of their length under the rider, such that the upper sub-frame tubes 121 collectively define an upper sub-frame slope plane 104 extending rearwardly and upwardly. The front end of each upper sub-frame tube 121 connects to the main frame 11 at an upper sub-frame connection point 1211. The front end of each lower sub-frame tube 122 connects to the main frame 11 at a lower sub-frame connection point 1221, with each lower sub-frame connection point 1221 being spaced rearwardly and downwardly from the respective left or right upper sub-frame connection point 1211. The vertical spacing between each upper sub-frame tube 121 and its respective lower sub-frame tube 122 decreases as the sub-frame tubes 121, 122 run rearwardly, until rear ends of the sub-frame tubes 121, 122 connect together. The upper sub-frame connection points 1211 are preferably substantially in line with the upper sub-frame tubes 121 and thus substantially within the upper sub-frame slope plane 104. The upper sub-frame connection points 1211 are preferably on a top side of and thus above the upper main tubes 112 and above the upper main tube slope plane 103. In the preferred embodiment, the sub-frame 12 is connected to the main frame 11 by bolts (not separately shown), and the upper sub-frame connection point 1211 and the lower sub-frame connection point 1221 are centers of the bolt through holes.

The geometry of the preferred frame 1 is further explained with reference several characteristic features called out in FIG. 3. An upper main tube parallel plane 105 is defined to run parallel to the upper main tube slope plane 103, intersecting the upper sub-frame connection points 1211. A main frame/sub-frame angle α is defined between the upper main tube parallel plane 105 and the upper sub-frame slope plane 104. The main frame/sub-frame angle α is preferably in the range from 100 to 150°, more preferably in the range from 112 to 138°, and most preferably about 125°. Too high of a value for the main frame/sub-frame angle α tends to increase the difficulty of supporting motorcycle 100 when parking. Too small of a value for the main frame/sub-frame angle α tends to reduce comfort of the driver's ride, particularly during off-road use when the driver frequently switches back and forth between standing riding and sitting riding.

A sub-frame connection spacing L1 is defined between each upper sub-frame connection point 1211 and its respective left or right lower sub-frame connection point 1221. A main frame span distance L2 is defined between the head tube axis 102 and a centerline of the lower sub-frame connection points 1221, measured within the longitudinal midplane 101 and perpendicular to the head tube axis 102. A sub-frame connection spacing/main frame span ratio L1/L2 of the sub-frame connection spacing L1 to the main frame span distance L2 is preferably in the range of 0.16 to 0.24, more preferably in the range of 0.18 to 0.22, and most preferably about 0.2. If the sub-frame connection spacing/main frame span ratio L1/L2 is too large, it will cause the connection between the lower sub-frame tubes 122 and the midframe legs 113 to shift downwards in the motorcycle 100, which can interfere with the arrangement and travel of the rear fork 31 and/or the rear wheel 42. A value for the sub-frame connection spacing/main frame span ratio L1/L2 which is too small can cause a reduction in connection strength between the sub-frame 12 and the main frame 11. Preferred values for the sub-frame connection spacing/main frame span ratio L1/L2 help ensure compactness and frame strength of the motorcycle 100, thereby improving the off-road performance and safety of the motorcycle 100 during driving.

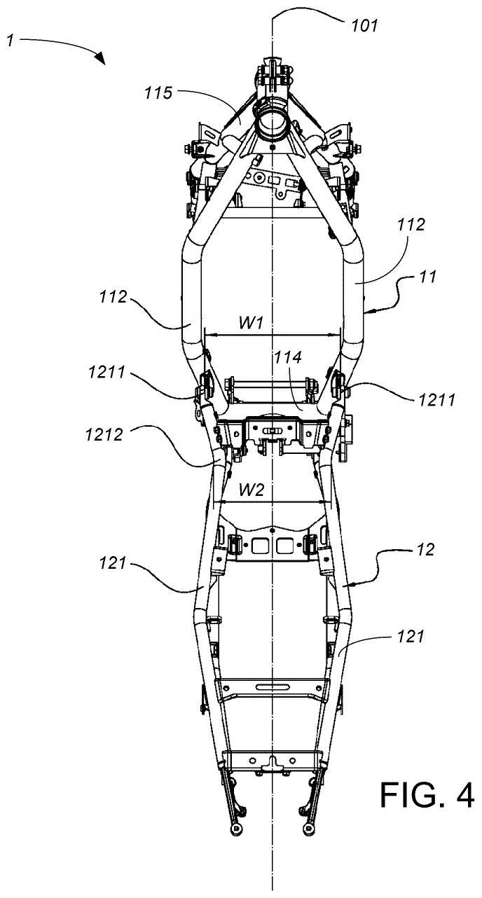

An upper sub-frame connection point width W1 is defined between the left and right upper sub-frame connection points 1211, measured as the distance between the contact surfaces between the upper sub-frame tubes 121 and the upper main tubes 112. As best shown in FIG. 4, the preferred upper sub-frame tubes 121 are wider at the upper sub-frame connection points 1211, getting narrower and then wider again as the upper sub-frame tubes 121 proceed rearwardly from the upper sub-frame connection points 1211. The upper sub-frame tubes 121 thus define a riding waist 1212, located rearward of the sub-frame connection points 1211. The riding waist 1212 is preferably positioned as close as possible to a saddle point 211 of the seat 21, so as to be directly under the rider while riding. The riding waist 1212 has a riding waist width W2, measured between the outer edges of the left and right upper sub-frame tubes 121 at the riding waist 1212. A riding waist ratio W2/W1 of the riding waist width W2 to the upper sub-frame connection point width W1 is preferably in the range of 0.7 to 1, more preferably in the range of 0.75 to 0.95, and most preferably about 0.85. The width of the seat cushion 21 is substantially the same as the underlying width of the sub-frame 12, including over the riding waist 1212. If the riding waist ratio W2/W1 is too large, the seat 21 or sub-frame 12 is more likely to interfere with the driver's legs in the width direction, making it harder to support the motorcycle 100 when stationary. Too large a value for riding waist ratio W2/W1 also tends to increase impact on the driver's legs when the driver stands and rides, reducing driver's comfort. Conversely, if the riding waist ratio W2/W1 is too small, there is likely to be less surface contact of the driver and the seat cushion 21 while sitting and riding, leading to insufficient support and reduced comfort. The preferred values for riding waist ratio W2/W1 help ensure the comfort of the driver's ride while meeting different driving scenarios of 60% off-road usage.

As shown in FIGS. 2 and 3, the sub-frame 12 further include left and right front sub-frame struts 123 and left and right rear sub-frame struts 124 fixedly connected between the respective upper and lower sub-frame tubes 121, 122. The top end of each front sub-frame strut 123 is positioned at or quite near the riding waist 1212 of the upper sub-frame tubes 121. This positioning of the front sub-frame struts 123 at the riding waist 1212 helps maintain high structural strength of the sub-frame 12. The preferred front sub-frame struts 123 each have a cross-sectional shape which is non-circular, such as being formed from cylindrical tubing compressed widthwise into an elliptical or rectangular cross-section. A battery 93 (shown schematically in FIG. 3) of the motorcycle 100 is preferably at least partially mounted on the sub-frame 12 in the space between the four sub-frame tubes 121, 122 and laterally between the front sub-frame struts 123, and non-circular front sub-frame struts 123 help to avoid interference between the battery 105 and the sub-frame 12 by increasing the gapwidth between the left and right front sub-frame struts 123 to accommodate the battery 93.

In order to enhance the aesthetics of the motorcycle 100, the body cover 2 includes a waist cover panel 22 which is at least partially arranged to extend outside and below the upper sub-frame tubes 121 as shown in FIG. 1, at least partially covering the front sub-frame strut 123. The seat 21 and the waist cover panel 22 help keep the driver's legs from contacting the sub-frame 12.

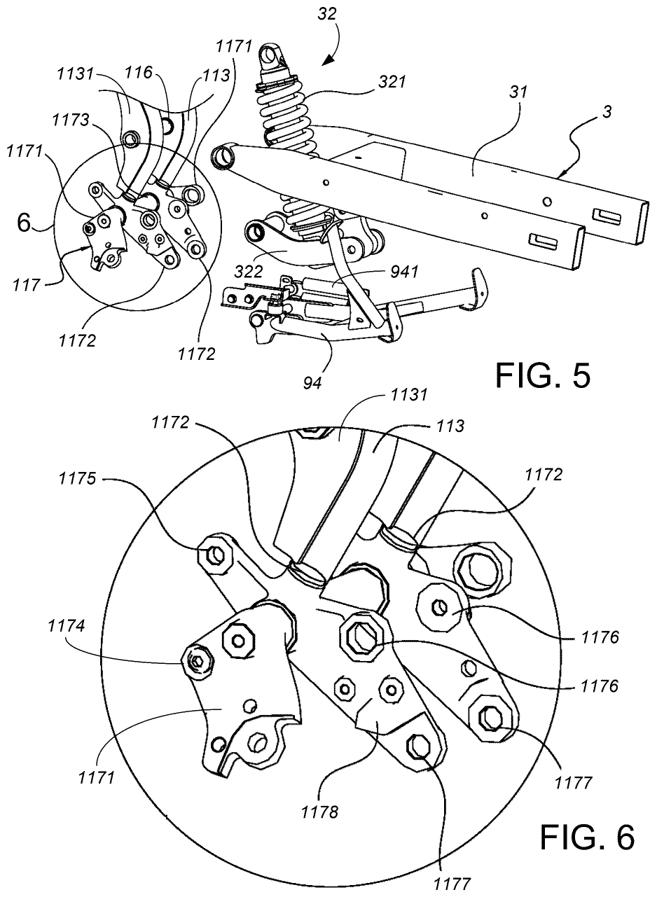

The main frame bottom mount section 117 is best shown in FIGS. 5-8. The main frame bottom mount section 117 includes left and right outside bottom mounts 1171, left and right inside bottom mounts 1172 and a bottom mount crossbar 1173 all fixedly connected relative to lower ends of the left and right midframe legs 113.

The outside bottom mounts 1171 preferably each include an underframe mount flange 1174 extending forwardly and below the elevation of the bottom mount crossbar 1173. The inside bottom mounts 1172 preferably each include a prime mover assembly (PMA) mount flange 1175 extending forwardly and above the elevation of the bottom mount crossbar 1173, a shock absorber mount flange 1176 extending rearwardly and slightly above the elevation of the bottom mount crossbar 1173, and a kickstand mount flange 1177 extending rearwardly and below the elevation of the bottom mount crossbar 1173. Each of these mount flanges 1174, 1175, 1176, 1177 preferably have a transversely-oriented through hole used for attaching the relevant component such as by bolting.

The suspension system 3 includes a rear shock absorber assembly 32 consisting of a rear shock absorber 321 and a rear shock absorber linkage 322 supporting the bottom end of the rear shock absorber 321 relative to the rear fork 31 and the main frame 11. The shock absorber mount flange 1176 is used to pivotally connect the forward end of the rear shock absorber linkage 322. The top end of the rear shock absorber 321 is pivotally connected to the main upper cross tube 114.

In the preferred embodiment, the shock absorber mount flange 1176 is further forward and closer to the bottom mount crossbar 1173 than the kickstand mount flange 1177 is to the bottom mount crossbar 1173. By having the shock absorber mount flange 1176 close to the bottom mount crossbar 1173, bending moments placed on the shock absorber mount flange 1176 by the rear shock absorber assembly 32 relative to its attachment (weld) to the bottom mount crossbar 1173 are smaller during operation. The inside bottom mounts 1172 can withstand greater shock forces and are less likely to deform under the forces of the rear shock absorber assembly 32, and the service life of the main frame bottom mount section 117 can be extended.

The motorcycle 100 includes a kickstand 94 for supporting the motorcycle 100 during parking. The kickstand 94 is pivotally connected to the main frame 11 by means of the kickstand mount flange 1177. The kickstand mount flange 1177 is positioned rearward and below the shock absorber mount flange 1176, such that interference between the kickstand 94 and the shock absorber assembly 32 is avoided. The preferred kickstand 94 includes a kickstand spring 941. Either or both of the inside bottom mounts 1172 have a kickstand limit arm 1178 extending outwardly relative to the longitudinal midplane 101. When the motorcycle 100 is supported on the ground by means of the kickstand 94, at least a portion of the kickstand 94 abuts against the kickstand limit arm 1178, stopping further pivoting under the action of the kickstand spring 941. Providing the kickstand limit arm 1178 as part of the main frame bottom mount section 117 leads to more consistent kickstand parking positioning relative to the frame 1.

The inside bottom mounts 1172 are fixedly connected to the vertically-extending midframe legs 113, such as by forming the inside bottom mounts 1172 by casting and attaching each inside bottom mount 1172 to its respective left or right midframe leg 113 by welding. For instance, the inside bottom mounts 1172 may partially extend into tubes of the midframe legs 113, increasing accuracy and strength and reducing errors in the welding process.

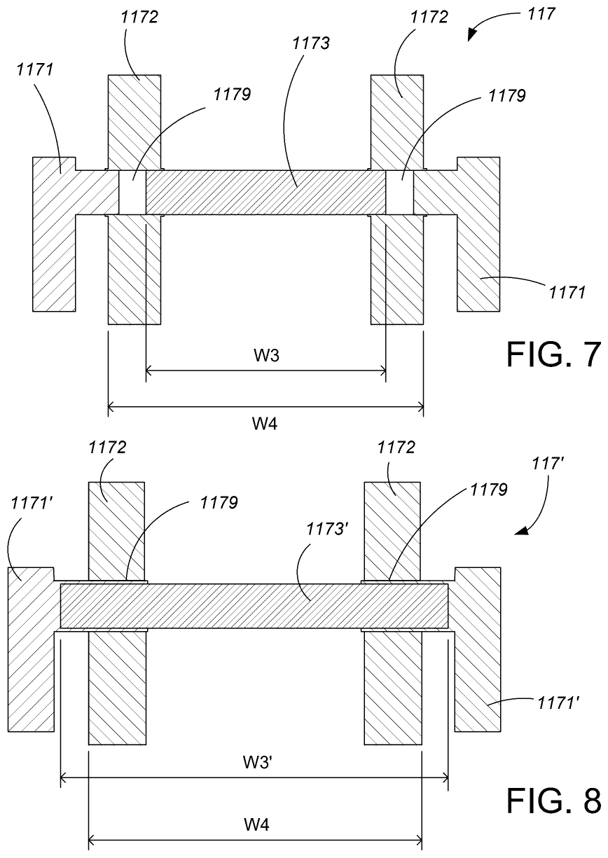

FIGS. 7 and 8 show simplified cross-sectional views of two different embodiments of the main frame bottom mount section 117, 117′. In both embodiments 117, 117′, the bottom mount crossbar 1173, 1173′ extends between and connects the two inside bottom mounts 1172. The bottom mount crossbar 1173, 1173′ has a bottom mount crossbar length W3, W3′, while the two inside bottom mounts 1172 have an inside bottom mount maximum width W4 between them. In the first embodiment of the main frame bottom mount section 117 shown in FIG. 7, the bottom mount crossbar 1173 terminates inside a bottom mount crossbar mounting throughhole 1179 (which could alternatively be two recesses), so the bottom mount crossbar length W3 is less than the inside bottom mount maximum width W4. The outside bottom mounts 1171 also extend into the bottom mount crossbar mounting throughhole 1179 but from the outer side, with the outside bottom mounts 1171 terminating within the bottom mount crossbar mounting throughhole 1179 for accurate and strong welding support. In the second embodiment of the main frame bottom mount section 117′ shown in FIG. 8, the bottom mount crossbar 1173′ extends fully through the bottom mount crossbar mounting throughhole 1179, so the bottom mount crossbar length W3′ is greater than the inside bottom mount maximum width W4. The outside bottom mounts 1171′ still preferably extend into the bottom mount crossbar mounting throughhole 1179, but sheathed around the bottom mount crossbar 1173′ for accurate and strong welding support. Both embodiments allow ease of assembly and accurate and strong welding of both the bottom mount crossbar 1173, 1173′ and the outside bottom mounts 1171, 1171′.

In summary, the PMA mount flange 1175, the shock absorber mount flange 1176, the kickstand mount flange 1177, and the bottom mount crossbar mounting throughhole 1179 are integrated within the left and right inside bottom mounts 1172, which simplifies and improves the welding process when fixing the prime mover assembly 5, the rear shock absorber assembly 32, and the kickstand 94.

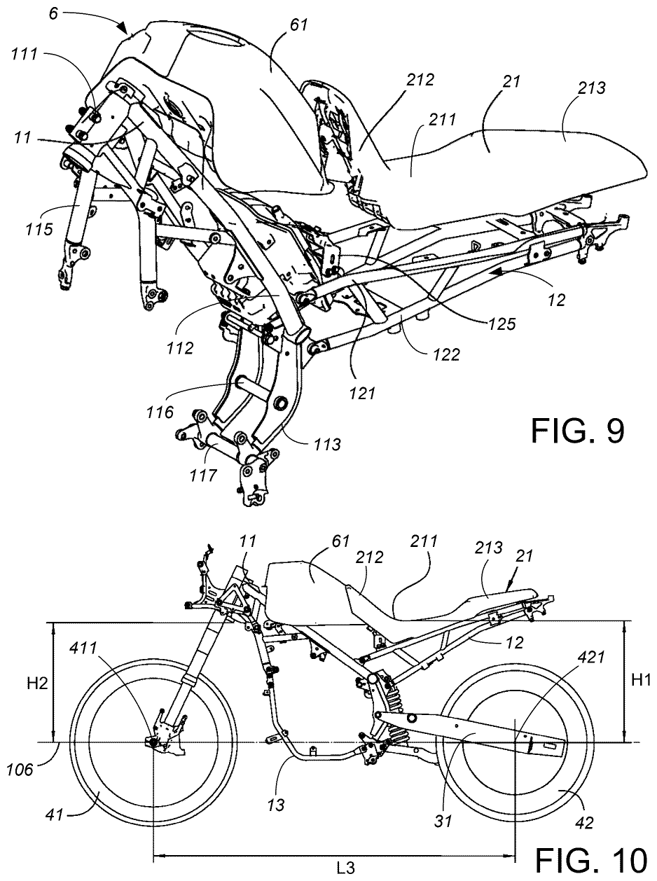

While other embodiments are electric motorcycles utilizing a battery storing electrical energy for locomotion of the motorcycle 100, the preferred motorcycle uses liquid fuel such as gasoline. Portions of the preferred fuel system 6 of the motorcycle 100 are further described with reference to FIGS. 9-11. The fuel system 6 includes a fuel tank 61 fixedly mounted on the main frame 11 above the upper main tubes 112 and partially above the upper subframe tubes 121. For instance, the subframe 12 can include a fuel tank support bracket 125 extending between the upper subframe tubes 121 as shown in FIGS. 2 and 9, which supports the rear end of the fuel tank 61. The front of the seat cushion 21 extends towards the upper front of motorcycle 100, and the front of the seat cushion 21 includes a pommel portion 212 which covers the rear top surface 611 of the fuel tank 61. In plan view, the pommel portion 212 of the seat cushion 21 preferably overlaps from 12 to 18% of the total plan view area 612 of the fuel tank 61, more preferably overlapping from 13 to 17% of the total plan view area 612 of the fuel tank 61, and most preferably overlapping about 15% of the total plan view area 612 of the fuel tank 61. For instance, the seat cushion 21 preferably overlaps from 65 to 255 cm² of the fuel tank 61, more preferably overlaps from 85 to 230 cm² of the fuel tank 61, and most preferably overlaps about 210 cm² of the fuel tank 61. By having substantial overlapping surface contact between the pommel portion 212 of the seat 21 and the fuel tank 211, pressure of the seat cushion 21 on the fuel tank 61 is reduced, avoiding mutual compression between the seat cushion 21 and the fuel tank 61, and reducing wear between the seat cushion 21 and the fuel tank 61, thus extending the service life of the seat cushion 21. Further, the fuel tank 61 is preferably formed of a metal such as steel having a high thermal conductivity. During warm and/or sunny weather, the fuel tank 61 can get quite hot. By having substantial overlapping surface contact between the pommel portion 212 of the seat 21 and the fuel tank 61, contact between the driver's body and the hot fuel tank 61 can be avoided, leading to a better driving experience. However, if the amount that the seat cushion 21 overlaps the fuel tank 61 is too large, then the seat cushion 21 can become too large and expensive.

The saddle point 211 of the seat cushion 21 is arranged behind the fuel tank 61. In side view as shown in FIG. 10, the saddle point 211 is the lowest point of seat cushion 21 along the longitudinal midplane 101, and the pommel portion 212 and a rear end 213 of the seat cushion 21 along the longitudinal midplane 101 are higher than the saddle point 211. A ride height H1 is defined as the elevation of the saddle point 211 above a wheel axis plane 106, where the wheel axis plane 106 is a generally horizontal plane containing both the front wheel axis 411 and a rear wheel axis 421. A wheelbase L3 is defined as the longitudinal distance from the front wheel axis 411 to the rear wheel axis 421. A ride height ratio H1/L3 of the ride height H1 to the wheelbase L3 is preferably within the range of 0.26 to 0.4, more preferably within the range of 0.3 to 0.36, and most preferably about 0.33. Having values for ride height ratio H1/L3 within these preferred ranges is conducive to the driver's support of the motorcycle 100 in a stationary state, while still being appropriate for repeated alternating between sitting driving and standing driving associated with off-road usage. The preferred values for ride height ratio H1/L3 not only provide riding comfort, but also meet the usage needs of drivers of different heights for the motorcycle 100 of the present application.

A head tube height H2 is defined as a distance between the lowest point of the head tube 111 and the wheel axis plane 106. A head tube height ratio H2/L3 of head tube height H2 to wheelbase L3 is preferably in the range of 0.35 to 0.55, more preferably in the range of 0.4 to 0.5, and most preferably about 0.45. A value for head tube height ratio H2/L3 which is too large will cause the driver's driving posture to be uncoordinated, while a value for head tube height ratio H2/L3 which is too small is not conducive to standing and riding, and further will reduce the maneuverability of motorcycle 100. A head tube height ratio H2/L3 within the preferred ranges not only avoids these problems, but also increases the stability of high-speed driving of the motorcycle 100.

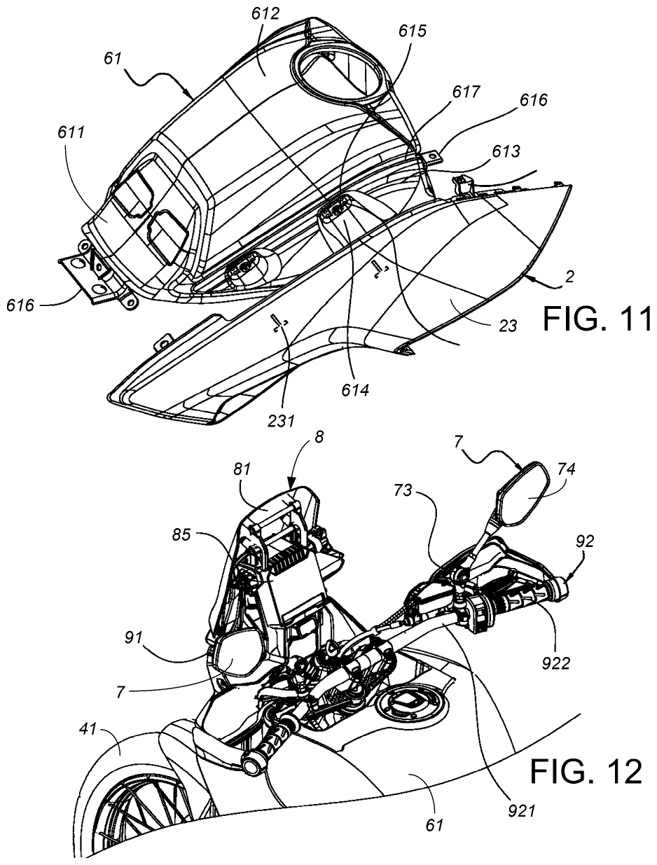

The vehicle body cover 2 includes left and right side panels 23 that at least partially cover left and right side edges 613 of the fuel tank 61, further explained with reference to FIG. 11. The side panels 23 are fixedly connected to the fuel tank 61 by means of fasteners 231. It should be noted that the surface of the fuel tank 61 is configured to a smooth plane or curved surface, which can result in warping at the connection position between the vehicle body cover 2 and the fuel tank 61, or at the edge of the vehicle body cover 2. In addition to being fixedly connected to the main frame 11, the side panels 23 are also at least partially detachably connected to the fuel tank 61 by means of fixing portions 614 of the fuel tank 61 located under the side panels 23. At least one, and more preferably two fixing portions 614 are provided on both left and right sides of the fuel tank 61. Each fixing portion 614 includes a groove that is recessed into the interior of the fuel tank 61 and a protrusion that protrudes outward from the fuel tank 61 for a fuel tank connection member 615. The fuel tank connection member 615 is a plastic part and has a through hole for fitting the fastener 231. The extension direction of the through hole is substantially parallel to the width direction of the motorcycle 100. When assembling the vehicle body cover 2 with the fuel tank 61, the assembler aligns the fastener 231 of the vehicle body cover 2 with the through hole of the fuel tank connection member 615, and translates the vehicle body cover 2 in the direction adjacent to the fuel tank 61 until the fastener 231 passes through the through hole of the fuel tank connection member 615, so that the fastener 231 is engaged with the fuel tank connection member 615.

It should be noted that when the vehicle body cover 2 is disassembled from the fuel tank 61, the vehicle body cover 2 should be translated away from the fuel tank 61 until the fastener 231 is detached from the fuel tank connection member 615. The front and rear ends of the fuel tank 61 are respectively equipped with mounting sheet metal 616 for fixing the vehicle body cover 2, and the mounting sheet metal 616 is a half ear sheet metal or “T-shaped” sheet metal.

In the preferred embodiment, a receiving groove 617 is further defined above each fixing portion 614, which is recessed into the interior of the fuel tank 61. The receiving groove 617 extends along the length direction of the motorcycle 100. The receiving groove 617 is preferably configured to a “U”-shaped groove, and the edge of the vehicle body cover 2 is embedded in the receiving groove 617. This not only limits the height direction of the motorcycle 100 for the side panels 23, but also effectively avoids the problem of side panel warpage. When the edge of the side panel 23 is at least partially received in the receiving groove 617, the size of mounting gap between the side panel 23 and the fuel tank 61 is reduced. The fixing portions 614 abut against the side panels 23, thereby ensuring the tightness of the connection between the fuel tank 61 and the vehicle body cover 2, thereby avoiding the edges of the side panels 23 from warping, and thereby improving the overall aesthetics of the motorcycle 100.

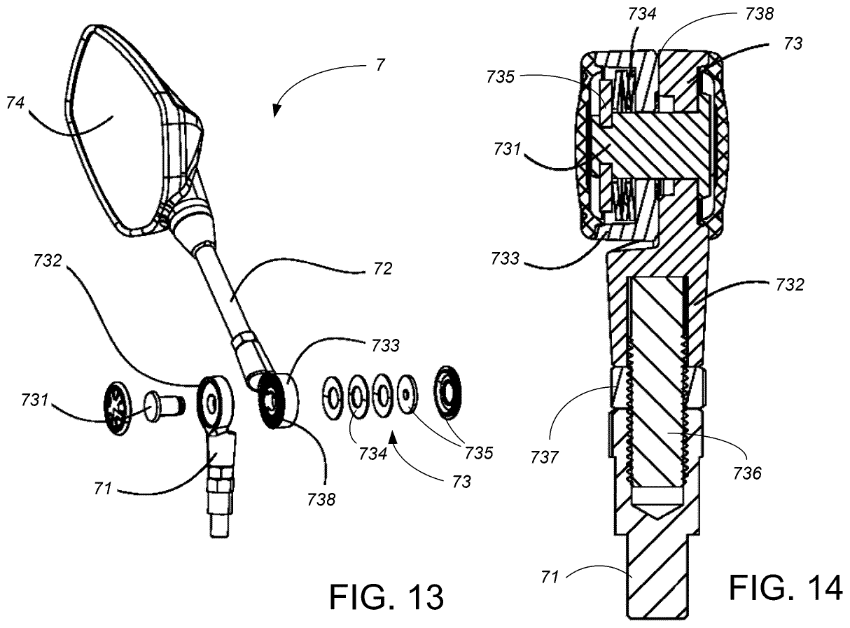

The preferred rear-view mirror assemblies 7 are further described with reference to FIGS. 12-14. The motorcycle 100 preferably includes left and right rear-view mirror assemblies 7, each supported from a handlebar 921 of the steering assembly 92 inside a handgrip 922, on left and right sides of and at least partially rearward of the windshield assembly 8.

Each rear-view mirror assembly 7 includes a proximal link 71 detachably fixed to the handlebar 921, a distal link 72 pivotally attached to the proximal link 71 by a pivot joint 73, and a mirror body 74 pivotally attached to the distal link 72. The mirror body 74 is capable of hand pivoting about an axis of the distal link 72. The pivot joint 73 includes a central fastener 731 which functions as a pivot pin. The pivot joint 72 allows pivoting both about an axis of the proximal link 71 and about an axis of the pivot pin 731. When the motorcycle 100 is being driven off-road, there is generally little or no traffic behind the motorcycle 100, and the function of the rear-view mirror assembly 7 is not required. The rear-view mirror assembly 7 allows hand folding of the mirror body 74 during riding from an on-road usage position to provide observation assistance for vehicles behind to a stowed, protected position which does not interfere with frontward viewing and prevents damage during high-speed, off-road running. Positioning the rear-view mirror assemblies 7 close to the handgrip 922 reduces the action range of the driver to adjust the rear-view mirror assembly 7 during riding, so as to improve the safety of the motorcycle 100 during riding. In addition, positioning the rear-view mirror assemblies 7 close to the handgrip 922 can also provide more adjustable space for the rear-view mirror assembly 7, avoiding interference between the rear-view mirror assembly 7 and the windshield assembly 8.

The preferred pivot joint 73 is similar to a Hirth coupling and, in addition to the pivot pin 731, the pivot joint 73 includes first and second mating rosettes 732, 733 which coaxially receive the pivot pin 731, a spring washer 734 sleeved on the pivot pin 731, a retainer clip 735 to axially secure the pivot pin 731, a threaded stud 736 and a tightening nut 737. The rosettes 732, 733 having mating teeth/grooves 738 that secure the relative circumferential positions of the rosettes 732, 733 during riding, but which through compression of the spring washer 734 allow the circumferential position of the second rosette 733 to be hand-changed relative to the first rosette 732 to allow folding of the mirror assembly 7. The spring washer 734 is preferably a butterfly spring. The threaded stud 736 threads into the proximal link 71 and, so long as the tightening nut 737 is loose, allows rotation of the pivot joint 73 about the axis of the proximal link 71. Tool tightening of the tightening nut 737 frictionally prevents further rotation of the pivot joint 73 about the axis of the proximal link 71, securing the pivot joint 73 in a desired circumferential orientation relative to the proximal link 71, that is, hand manipulation of the mirror body 74 only results in pivoting of the mirror body 74 about the axis of the pivot pin 731 and/or about the axis of the distal link 73, not about the axis of the proximal link 71. The rear-view mirror assembly 7 has high stability, making it easier for the driver to observe the rear environment of motorcycle 100 through the mirror body 74 when desired, but also allowing quick and easy hand movement of the mirror body 74 between the on-road usage position and the stowed, protected position.

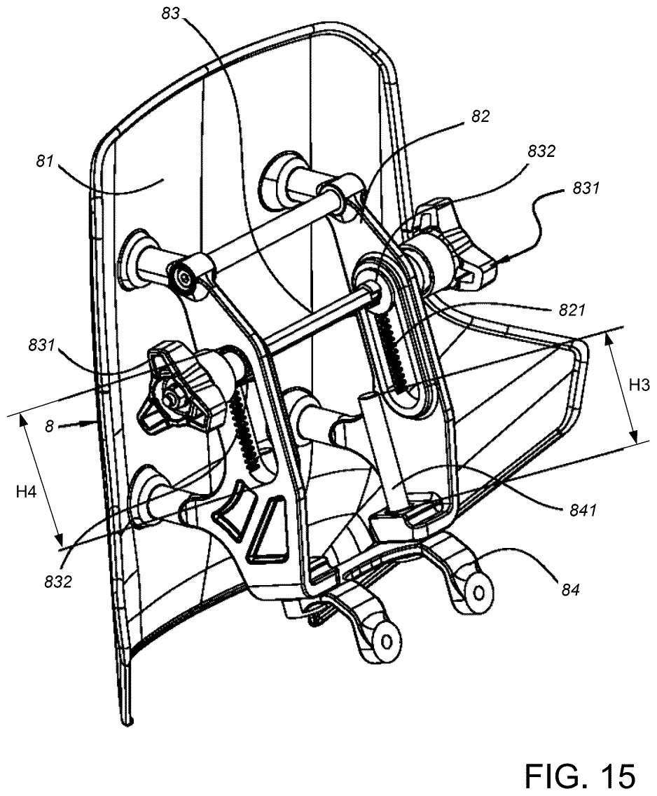

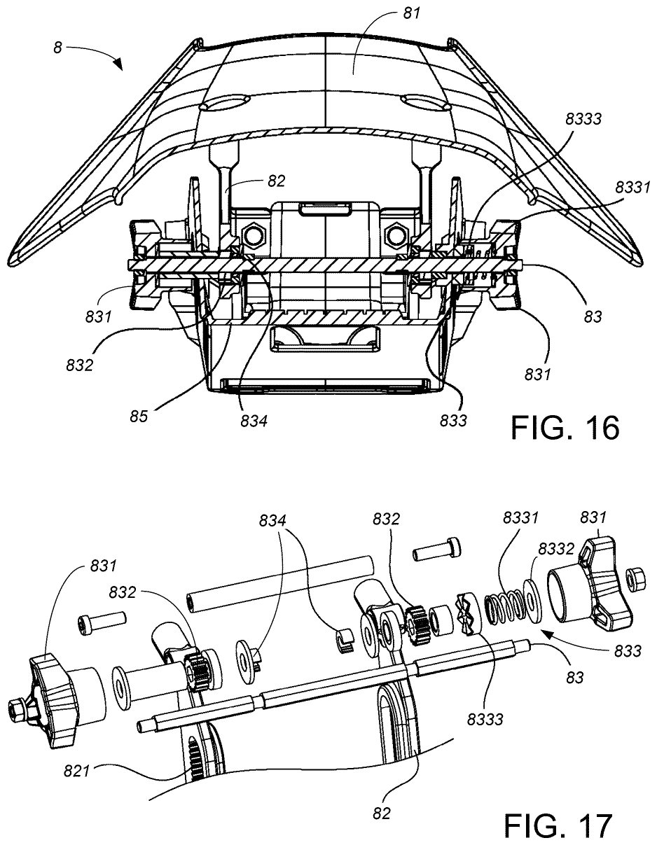

The preferred windshield assembly 8 is further described with reference to FIGS. 15-17. The windshield assembly 8 includes a windshield 81, a windshield mount 82 having left and right racks 821, an adjusting shaft 83 having left and right hand knobs 831 and left and right pinions 832, a guide 84 having left and right guide rails 841, and a support stand 85 for the adjusting shaft 83. The windshield 81 is positioned at the front of the windshield assembly 8, primarily as a transparent or translucent plate that is used to guide airflow to pass above the driver during riding while still allowing the driver to view forwardly through the windshield 81. The windshield mount 82 is fixedly connected to the windshield 81. The racks 821 of the windshield mount 82 are gear meshed with the pinions 832 of the adjusting shaft 83. The adjusting shaft 83 is rotationally supported at a fixed elevation by the support stand 85, while the windshield mount 82 can slide vertically along the guide rails 841. The guide 84 and the support stand 85 (not shown in FIG. 15) are fixed to the frame 1 of the motorcycle 100. The support stand 85 also partially encloses and protects interior components such as the pinions 832 and the rack 821 from debris and/or from inadvertent contact with the driver's fingers. The extension direction of the guide rails 841 is parallel to the extension direction of the racks 821. The driver can hand turn one or both hand knobs 831 to rotate the adjusting shaft 83 and its pinions 832, with the pinions 832 each pushing their respective racks 821 up or down such that the windshield mount 82 is moved vertically up or down on the guide rails 841. Thus, simply by rotating the hand knobs 831, the height of the windshield 81 can be adjusted to meet the needs of drivers with different body shapes and different statures.

Each of the guide rails 841 have a guide rail height H3, and each of the racks 821 have a rack height H4, both called out in FIG. 15. The guide rail height H3 is greater than or equal to the rack height H4, thereby preventing windshield mount 82 from detaching off the guide rails 841 when the windshield 81 rises to its maximum height. Alternative embodiments use a different number of racks 821/pinions 832 other than two and/or a different number of guide rails 841 other than two, but providing left and right coupling provides balance to the windshield assembly 8 and helps prevent binding.

The preferred windshield assembly 8 includes a claw structure 833 disposed inside either the left or right hand knob 831. The claw structure 833 includes a compression spring 8331, a retainer clip 8332 and a ridged rosette 8333, with the retainer clip 8332 fixed to the adjusting shaft 83 and with the ridged rosette 8333 after assembly fixed relative to its hand knob 831. The compression spring 8331 is sleeved around the adjusting shaft 83, held between the retainer clip 8332 and the outward side of the ridged rosette 8333. That hand knob 831 and the ridged rosette 8333 are rotationally keyed to the adjusting shaft 83, but can slide outwardly (axially) for a limited distance relative to the adjusting shaft 83, until the compression spring 8331 is fully compressed between the ridged rosette 8333 and the axially fixed retainer clip 8332. When no axial force is applied to the hand knob 831, the inward side of the ridged rosette 8333 mates into the support stand 85 to prevent the hand knob 831 and the adjusting shaft 83 from rotating, thus fixing the height of the windshield 81 and preventing the windshield 81 from slipping up or down during riding. To rotate the hand knobs 831 (and the adjusting shaft 83 and its pinions 832), the user must first axially pull the associated hand knob 831 to separate the ridged rosette 8333 relative to the support stand 85. Two ring clamps 834 are used to secure the axial (left to right) position of the adjusting shaft 83 relative to the windshield mount 82, sufficiently strong to withstand the pull force on the hand knob 831.

In the description of the present application, it should be understood that the phrase ‘one component is located on the inner side of another component’ means that one component is located on the side of another component away from the body cover or the outer surface of the motorcycle.

In the description of the present application, it should be understood that the term “length direction” refers to the front to rear direction of the vehicle parallel to the motorcycle driver while driving, the term “width direction” refers to the left to right direction of the vehicle parallel to the motorcycle driver while driving, and the term “height direction” refers to the up and down direction of the vehicle parallel to the motorcycle driver while driving.

It should be understood that the specific embodiments described here are only used to explain preferred embodiments of the present invention, not to limit it. According to the embodiments provided in the present application, all other embodiments obtained by ordinary skilled persons in this field without creative labor are within the scope of protection of the present invention.

The accompanying drawings are only some examples or embodiments of the present application. For those skilled in the art, the present invention can also be applied to other similar situations based on these drawings, but without the need for creative labor. Furthermore, it can be understood that although the work done during this development process may be complex and lengthy, for ordinary technical personnel in this field, certain design, manufacturing, or production changes made based on the technical content disclosed in the present application are only conventional technical means and should not be considered as insufficient content disclosed in the present application.

The above embodiments only express several embodiments of the present invention, and their descriptions are more specific and detailed, but should not be understood as limiting the scope of patent protection. It should be pointed out that for ordinary technical personnel in this field, several modifications and improvements can be made without departing from the concepts of the present invention, which are within the scope of protection of the present application. Therefore, the scope of protection of the present application should be based on the attached claims.

1. A motorcycle comprising
a frame comprising:
a main frame having a head tube, at least one upper main tube extending rearwardly from the head tube, and at least one midframe leg extending downwardly from a rear end of the at least one upper main tube, the head tube having a head tube axis, the main frame having a longitudinal mid-plane; and
a sub-frame fixedly connected to the main frame and extending rearwardly from the rear end of the at least one upper main tube, the sub-frame having left and right upper sub-frame tubes each extending rearwardly from an upper sub-frame connection point where the upper sub-frame tube connects to the main frame, with a riding waist defined between the left and right upper sub-frame tubes, the sub-frame having left and right lower sub-frame tubes each extending rearwardly from a lower sub-frame connection point where the lower sub-frame tube connects to the main frame, with a sub-frame connection spacing defined between the upper sub-frame connection point and the respective lower sub-frame connection point, and with a main frame span distance being defined between the head tube axis and a centerline of the lower sub-frame connection points, measured within the longitudinal midplane and perpendicular to the head tube axis;
wheels connected to the frame, the wheels comprising a front wheel rotating about a front wheel axis and a rear wheel rotating about a rear wheel axis, with a wheelbase defined as a distance between the front wheel axis and the rear wheel axis, and with a wheel axis plane defined as a plane containing the front wheel axis and the rear wheel axis;
a prime mover assembly coupled to at least the rear wheel in a transmission mode; and
a vehicle body cover comprising a straddle-type seat cushion at least partially arranged above the sub-frame and the main frame, wherein a ride height is defined as an elevation difference between wheel axis plane and the seat cushion directly above the riding waist;
wherein a sub-frame connection spacing/main frame span ratio of the sub-frame connection spacing divided by the main frame span distance is in the range from 0.16 to 0.24, and wherein a ride height ratio of the ride height divided by the wheelbase is in the range from 0.26 to 0.4.

2. The motorcycle of claim 1, wherein an upper sub-frame connection point width is defined as a distance between the left and right upper sub-frame connection points, wherein a riding waist width is defined as a distance between outer edges of the left and right upper sub-frame tubes at the riding waist, and wherein a riding waist ratio of the riding waist width divided by the upper sub-frame connection point width is in the range from 0.7 to 1.

3. The motorcycle of claim 2, wherein the sub-frame further comprises left and right front sub-frame struts running between and connecting the respective upper sub-frame tube to the respective lower sub-frame tube, wherein the riding waist is positioned between the sub-frame struts.

4. The motorcycle of claim 3, wherein the left and right front sub-frame struts have a non-circular cross-section.

5. The motorcycle of claim 1, comprising left and right upper main tubes both extending within an upper main tube slope plane, wherein an upper main tube parallel plane is defined parallel to the upper main tube slope plane and through the upper sub-frame connection points, wherein the left and right upper sub-frame tubes extend within an upper sub-frame slope plane, and wherein the upper main tube parallel plane is at a main frame/sub-frame angle relative to the upper sub-frame slope plane in the range from 100 to 150°.

6. The motorcycle of claim 1, wherein the frame further comprises a main frame bottom mount section fixed to a bottom end of the at least one midframe leg, the main frame bottom mount section having left and right outside bottom mounts, left and right inside bottom mounts and a bottom mount crossbar.

7. The motorcycle of claim 6, wherein the left and right inside bottom mounts each comprise a prime mover assembly mount flange, a rear shock absorber mount flange and a kickstand mount flange.

8. The motorcycle of claim 1, wherein the frame further comprises an underframe arranged below the main frame, and the underframe is detachably connected to the main frame.

9. The motorcycle of claim 1, wherein a vertical distance between the lowest point of the head tube and the wheel axis plane is defined as a head tube height, and wherein a head tube height ratio of the head tube height to the wheelbase is in the range from 0.35 to 0.55.

10. The motorcycle of claim 1, wherein the motorcycle further comprises a fuel tank at least partially arranged on the main frame, and wherein the seat cushion comprises a pommel portion vertically overlapping a rear top surface of the fuel tank.

11. The motorcycle of claim 1, wherein the pommel portion of the seat cushion vertically overlaps from 12 to 18% of a total plan view area of the fuel tank.

12. A motorcycle comprising
a frame comprising:
a main frame having a head tube, left and right upper main tubes extending rearwardly from the head tube to a main upper cross tube, and left and right midframe legs extending downwardly from the main upper cross tube, the head tube having a head tube axis, the main frame having a longitudinal mid-plane; and
a sub-frame fixedly connected to the main frame and extending rearwardly from the main frame, the sub-frame having left and right upper sub-frame tubes each extending rearwardly from an upper sub-frame connection point where the upper sub-frame tube connects to the main frame, with a riding waist defined between the left and right upper sub-frame tubes, the sub-frame having left and right lower sub-frame tubes each extending rearwardly from a lower sub-frame connection point where the lower sub-frame tube connects to the main frame, with a sub-frame connection spacing defined between the upper sub-frame connection point and the respective lower sub-frame connection point, and with a main frame span distance being defined between the head tube axis and a centerline of the lower sub-frame connection points, measured within the longitudinal midplane and perpendicular to the head tube axis;
wheels connected to the frame, the wheels comprising a front wheel rotating about a front wheel axis and a rear wheel rotating about a rear wheel axis, with a wheelbase defined as a distance between the front wheel axis and the rear wheel axis, and with a wheel axis plane defined as a plane containing the front wheel axis and the rear wheel axis;
a prime mover assembly coupled to at least the rear wheel in a transmission mode; and
a vehicle body cover comprising a straddle-type seat cushion at least partially arranged above the sub-frame and the main frame;
wherein a sub-frame connection spacing/main frame span ratio of the sub-frame connection spacing divided by the main frame span distance is in the range from 0.16 to 0.24.

13. The motorcycle of claim 12, wherein an upper sub-frame connection point width is defined as a distance between the left and right upper sub-frame connection points, wherein a riding waist width is defined as a distance between outer edges of the left and right upper sub-frame tubes at the riding waist, and wherein a riding waist ratio of the riding waist width divided by the upper sub-frame connection point width is in the range from 0.7 to 1.

14. The motorcycle of claim 12, wherein the left and right upper main tubes both extending within an upper main tube slope plane, wherein an upper main tube parallel plane is defined parallel to the upper main tube slope plane and through the upper sub-frame connection points, wherein the left and right upper sub-frame tubes extend within an upper sub-frame slope plane, and wherein the upper main tube parallel plane is at a main frame/sub-frame angle relative to the upper sub-frame slope plane in the range from 100 to 150°.

15. The motorcycle of claim 12, wherein the left and right midframe legs each have a midframe reinforcement plate extending in a vertical/longitudinal plane, wherein the frame further comprises a main frame bottom mount section fixed to a bottom end of the left and right midframe legs, the main frame bottom mount section having left and right outside bottom mounts, left and right inside bottom mounts and a bottom mount crossbar, and wherein the left and right inside bottom mounts each comprise a prime mover assembly mount flange, a rear shock absorber mount flange and a kickstand mount flange.

16. The motorcycle of claim 12, wherein the motorcycle further comprises:
a steering assembly with a handlebar; and
at least one rear-view mirror assembly mounted on the handlebar, the rear-view mirror assembly comprising a mirror body, a distal link, a proximal link and a pivot joint connecting the distal link to the proximal link, the pivot joint comprising a pivot pin extending through first and second mating rosettes and a spring washer, the pivot joint allowing hand pivoting of the mirror body from an on-road usage position to provide observation assistance for vehicles behind to a stowed, protected position which does not interfere with frontward viewing and prevents damage during high-speed, off-road running.

17. The motorcycle of claim 12, wherein the motorcycle further comprises a front windshield assembly, the front windshield assembly comprising:
a windshield;
a windshield mount secured to the windshield and having at least one rack;
an adjusting shaft supporting at least one pinion in meshed engagement with the at least one rack;
a support stand supporting the adjusting shaft at a fixed elevation; and
at least one guide rail which allows the windshield to be raised or lowered by rotation of the adjusting shaft.

18. The motorcycle of claim 17, wherein the guide rail has a guide rail height, wherein the rack has a rack height, and wherein the guide rail height is greater than or equal to the rack height, thereby preventing windshield mount from detaching off the at least one guide rail when the windshield rises to its maximum height.

19. A motorcycle comprising
a frame comprising:
a main frame having a head tube, at least one upper main tube extending rearwardly from the head tube, at least one midframe leg extending downwardly from a rear end of the at least one upper main tube, and a main frame bottom mount section fixed to a bottom end of the at least one midframe leg, the main frame bottom mount section having left and right outside bottom mounts, left and right inside bottom mounts and a bottom mount crossbar, wherein the left and right inside bottom mounts each comprise a prime mover assembly mount flange, a rear shock absorber mount flange and a kickstand mount flange, the head tube having a head tube axis, the main frame having a longitudinal mid-plane ; and
a sub-frame fixedly connected to the main frame and extending rearwardly from the rear end of the at least one upper main tube, the sub-frame having left and right upper sub-frame tubes each extending rearwardly from an upper sub-frame connection point where the upper sub-frame tube connects to the main frame, with a riding waist defined between the left and right upper sub-frame tubes, the sub-frame having left and right lower sub-frame tubes each extending rearwardly from a lower sub-frame connection point where the lower sub-frame tube connects to the main frame, with a sub-frame connection spacing defined between the upper sub-frame connection point and the respective lower sub-frame connection point, and with a main frame span distance being defined between the head tube axis and a centerline of the lower sub-frame connection points, measured within the longitudinal midplane and perpendicular to the head tube axis;
wheels connected to the frame, the wheels comprising a front wheel rotating about a front wheel axis and a rear wheel rotating about a rear wheel axis, with a wheelbase defined as a distance between the front wheel axis and the rear wheel axis, and with a wheel axis plane defined as a plane containing the front wheel axis and the rear wheel axis;
a prime mover assembly coupled to at least the rear wheel in a transmission mode; and
a vehicle body cover comprising a straddle-type seat cushion at least partially arranged above the sub-frame and the main frame;
wherein a sub-frame connection spacing/main frame span ratio of the sub-frame connection spacing divided by the main frame span distance is in the range from 0.16 to 0.24.

20. The motorcycle of claim 19, wherein an upper sub-frame connection point width is defined as a distance between the left and right upper sub-frame connection points, wherein a riding waist width is defined as a distance between outer edges of the left and right upper sub-frame tubes at the riding waist, and wherein a riding waist ratio of the riding waist width divided by the upper sub-frame connection point width is in the range from 0.7 to 1.
